(19) United States
(12) Patent Application Publication
(10) Pub. No.: US 2025/0380336 A1
(43) Pub. Date: Dec. 11, 2025

(54) Method of Multiple Timing-Advances for Uplink Transmission in One Cell

(71) Applicant: ZTE Corporation, Shenzhen (CN)

(72) Inventors: Fei DONG, Shenzhen (CN); He HUANG, Shenzhen (CN); Jing LIU, Shenzhen (CN); Mengjie ZHANG, Shenzhen (CN); Yang ZHANG, Shenzhen (CN); Xiaolong GUO, Shenzhen (CN)

(73) Assignee: ZTE Corporation, Shenzhen (CN)

(21) Appl. No.: 19/301,723

(22) Filed: Aug. 15, 2025

Related U.S. Application Data
(63) Continuation of application No. PCT/CN2023/087120, filed on Apr. 7, 2023.

(51) Int. Cl. H04W 76/38; H04L 1/1812; H04L 5/00

(52) U.S. Cl. CPC H04W 76/38; H04L 1/1812; H04L 5/0044

(57) ABSTRACT

This disclosure is directed generally to wireless communication network and particularly to Time Advance (TA) management for multipoint transmission/reception in one cell. Various example implementations are described for the serving cell to configure and signal an association between TRPs of the serving cell with the multiple TAs managed by a wireless terminal and for the wireless terminal to obtain initial and updated TAs for these TRPs. Various additional embodiments are further disclosed, providing example procedures for handling uplink Time Alignment Timer (TAT) expiration when multiple TRPs are involved, particularly when TATs for some TRPs have expired whereas TATs for some other TRPs are still available.

### TECHNICAL FIELD

This disclosure is directed generally to wireless communication network and particularly to Time Advance (TA) management for multipoint transmission/reception in one cell.

### BACKGROUND

In cellular wireless network, for transmission time synchronization purposes, the network side may require a wireless terminal to take into consideration of transmission time delay for an uplink transmission by initiate the transmission by a time advance (TA) prior to a scheduled reception time by a network node. The amount of TA may be determined by a signal propagation delay between the wireless terminal and the wireless network node. The TA may change as the wireless terminal move within a serving cell or from one serving cell to another serving cell. TA management for the wireless terminal is thus a critical aspect in the wireless network.

### SUMMARY

This disclosure is directed generally to wireless communication network and particularly to Time Advance (TA) management for multipoint transmission/reception in one cell. Specifically, when multiple Transmission/Reception Points (mTRP) are provided in a serving cell for an mTRP capable wireless terminal, each mTRP may be associated with a TA for uplink transmission from the wireless terminal. The TAs of these multiple TRPs may be distinct. In order for the wireless terminal to correctly determine a TA to apply to a scheduled uplink transmission, an association between a TA identifier and a TRP must be provided to the wireless terminal. The disclosure below describes various example implementations for the serving cell to configure and signal such association to the wireless terminal and for the wireless terminal to obtain initial and updated TAs for these TRPs. Various additional embodiments are further described, providing example procedures for handling uplink Time Alignment Timer (TAT) expiration when multiple TRPs are involved, particularly when TATs for some TRPs have expired whereas TATs for some other TRPs are still available.

In one example embodiment, a method performed by a wireless terminal in communication with a serving cell is disclosed. The method may include determining whether a first active Time Alignment Timer (TAT) and a second active TAT have expired, the first active TAT and the second active TAT being associated with a first Time-Advance-Group (TAG) and a second TAG, respectively, and the first TAG and the second TAG being associated with a first Transmit-Receive Point (TRP) and a second TRP, respectively; performing a first procedure when determining that the first TAT has expired while the second TAT is still available; and performing a second procedure when determining that the first TAT and the second TAT have both expired, the second procedure being distinct from the first procedure.

In the example implementation above, the first procedure comprises automatically attributes resources associated with the first TRP to the second TRP.

In any one of the example implementations above, the first procedure comprises suspending resources associated with the first TRP. The first procedure comprises release resources associated with the first TRP. The resources comprise at last one of PUCCH resources and Sounding Reference Signal (SRS) resources.

In any one of the example implementations above, the second procedure comprises one or more of: flushing all Hybrid Automatic Repeat Request (HARQ) buffers for the serving cell; notifying a Radio Research Control (RRC) entity to release configured PUCCH for the serving cell; notifying the RRC entity to release configured SRS resources for the serving cell; clearing configured downlink assignments and uplink grants for the serving cell; clearing PUSCH resources for semi-persistent Channel-State-Information (CSI) reporting; or maintaining current time advance values of the first TAG and the second TAG.

In any one of the example implementations above, the serving cell comprises a special cell (spCell), the special cell being either a primary cell or a primary secondary cell; and the second procedure further comprises setting all running TATs as expired.

In any one of the example implementations above, the first TAG maps to a first Control Resource SET (CORESET) pool configured by the serving cell for the wireless terminal; and the second TAG maps to a second CORESET pool configured by the serving cell for the wireless terminal.

In any one of the example implementations above, the first TAG and the second TAG correspond to a first activated transmission configuration indicator (TCI) state and a second activated TCI state of the serving cell respectively, the first activated TCI state and the second activated TCI state being associated with the first TRP and the second TRP and being among a list of TCL states of the serving cell corresponding to a plurality of TRPs.

In any one of the example implementations above, one of the first TAG and the second TAG maps to one of a plurality of Control Resource SET (CORESET) pools configured by the serving cell for the wireless terminal; and the other of the first TAG and the second TAG correspond to an activated TCI state among a list of TCI states associated with a plurality of TRPs.

In any one of the example implementations above, the first activated TCI state, the second activated TCI state, or the activated TCI state among the list of TCI states is dynamically indicated via a MAC CE.

In some other implementations, a method performed by a wireless terminal in communication with a serving cell is disclosed. The method may include determining whether a first time alignment timer (TAT) and a second TAT have expired, the first TAT and the second TAT being associated with a first time advance group (TAG) and a second TAG, respectively, and the first TAG and the second TAG being associated with a primary transmit-receive point (TRP) and a secondary TRP, respectively; performing a first procedure when determining that the second TAT has expired while the first TAT is still available; and performing a second procedure when determining that the first TAT has expired regardless of whether the second TAT has expired, the second procedure being distinct from the first procedure.

In the example implementations above, the first procedure comprises automatically attributes resources associated with the secondary TRP to the primary TRP. the first procedure comprises suspending resources associated with the secondary TRP. The first procedure comprises release resources associated with the secondary TRP. The resources comprise at last one of PUCCH resources and Sounding Reference Signal (SRS) resources.

In any one of the example implementations above, the second procedure comprises one or more of: flushing all HARQ buffers for the serving cell; notifying RRC entity to release configured PUCCH for the serving cell; notifying the RRC entity to release configured SRS resources for the serving cell; clearing configured downlink assignments and uplink grants for the serving cell; clearing PUSCH resources for semi-persistent CSI reporting; or maintaining current time advance values of the first TAG and the second TAG.

In any one of the example implementations above, the serving cell comprises a special cell (spCell), the special cell being either a primary cell or a primary secondary cell; and the second procedure further comprises one or more of: flushing all HARQ buffers for the serving cell; notifying RRC entity to release configured PUCCH for the serving cell; notifying the RRC entity to release configured SRS resources for the serving cell; clearing configured downlink assignments and uplink grants for the serving cell; clearing PUSCH resources for semi-persistent CSI reporting; considering all running TATs as expired; or maintaining current time advance values of the first TAG and the second TAG.

In any one of the example implementations above, the first TAG maps to a first Control Resource SET (CORESET) pool configured by the serving cell for the wireless terminal; and the second TAG maps to a second CORESET pool configured by the serving cell for the wireless terminal.

In any one of the example implementations above, the first TAG and the second TAG correspond to a first activated transmission configuration indicator (TCI) state and a second activated TCI state of the serving cell respectively, the first activated TCI state and the second activated TCI state being associated with the primary TRP and the secondary TRP and being among a list of TCL states of the serving cell corresponding to a plurality of TRPs.

In any one of the example implementations above, one of the first TAG and the second TAG maps to one of a plurality of CORESET pools configured by the serving cell for the wireless terminal; and the other of the first TAG and the second TAG correspond to an activated TCI state among a list of TCI states associated with a plurality of TRPs.

In any one of the example implementations above, the first activated TCI state, the second activated TCI state, or the activated TCI state among the list of TCI states is dynamically indicated via a MAC CE.

In some other embodiments, an electronic device comprising a memory for storing instructions and a processor for executing the instructions to implement any of the methods above.

In yet some other embodiments, a computer program product comprising a non-transitory computer-readable program medium with computer code stored thereupon is disclosed. The computer code, when executed by a processor, may cause the processor to implement any one of the methods above.

The above embodiments and other aspects and alternatives of their implementations are described in greater detail in the drawings, the descriptions, and the claims below.

### BRIEF DESCRIPTION OF THE DRAWINGS

FIG. 1 illustrates an example wireless communication network including a wireless access network, a core network, and data networks.

FIG. 2 illustrates an example wireless access network including a plurality of mobile stations/terminals or User Equipments (UEs) and a wireless access network node in communication with one another via an over-the-air radio communication interface.

FIG. 3 shows an example radio access network (RAN) architecture.

FIG. 4 shows an example communication protocol stack in a wireless access network node or wireless terminal device including various network layers.

FIG. 5 illustrates an example procedure for PDCCH ordered RACH for obtaining TRP specific TA.

### DETAILED DESCRIPTION

The technology and examples of implementations and/or embodiments described in this disclosure can be used to configure and manage time advance in multipoint transmit-receive environment in wireless communication networks. The term “over-the-air interface” is used interchangeably with “air interface” or “radio interface” in this disclosure. The term “exemplary” is used to mean “an example of” and unless otherwise stated, does not imply an ideal or preferred example, implementation, or embodiment. Section headers are used in the present disclosure to facilitate understanding of the disclosed implementations and are not intended to limit the disclosed technology in the sections only to the corresponding section. The disclosed implementations may be further embodied in a variety of different forms and, therefore, the scope of this disclosure or claimed subject matter is intended to be construed as not being limited to any of the embodiments set forth below. The various implementations may be embodied as methods, devices, components, systems, or non-transitory computer readable media. Accordingly, embodiments of this disclosure may, for example, take the form of hardware, software, firmware or any combination thereof.

This disclosure is directed generally to wireless communication network and particularly to Time Advance (TA) management for multipoint transmission/reception in one cell. Specifically, when multiple Transmission/Reception Points (mTRP) are provided in a serving cell for an mTRP capable wireless terminal, each mTRP may be associated with a TA for uplink transmission from the wireless terminal. The TAs of these multiple TRPs may be distinct. In order for the wireless terminal to correctly determine a TA to apply to a scheduled uplink transmission, an association between a TA identifier and a TRP must be provided to the wireless terminal. The disclosure below describes various example implementations for the serving cell to configure and signal such association to the wireless terminal and for the wireless terminal to obtain initial and updated TAs for these TRPs. Various additional embodiments are further described, providing example procedures for handling uplink Time Alignment Timer (TAT) expiration when multiple TRPs are involved, particularly when TATs for some TRPs have expired whereas TATs for some other TRPs are still available.

### Wireless Network Overview

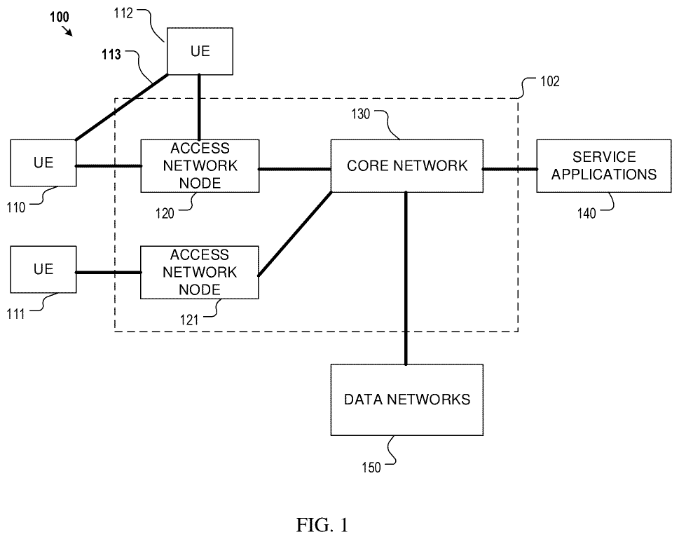

An example wireless communication network, shown as 100 in FIG. 1, may include wireless terminal devices or user equipment (UE) 110, 111, and 112, a carrier network 102, various service applications 140, and other data networks 150. The wireless terminal devices or UEs, may be alternatively referred to as wireless terminals. The carrier network 102, for example, may include access network nodes 120 and 121, and a core network 130. The carrier network 110 may be configured to transmit voice, data, and other information (collectively referred to as data traffic) among UEs 110, 111, and 112, between the UEs and the service applications 140, or between the UEs and the other data networks 150. The access network nodes 120 and 121 may be configured as various wireless access network nodes (WANNs, alternatively referred to as wireless base stations) to interact with the UEs on one side of a communication session and the core network 130 on the other. The term “access network” may be used more broadly to refer a combination of the wireless terminal devices 110, 111, and 112 and the access network nodes 120 and 121. A wireless access network may be alternatively referred to as Radio Access Network (RAN). The core network 130 may include various network nodes configured to control communication sessions and perform network access management and traffic routing. The service applications 140 may be hosted by various application servers deployed outside of but connected to the core network 130. Likewise, the other data networks 150 may also be connected to the core network 130.

In the example wireless communication network of 100 of FIG. 1, the UEs may communicate with one another via the wireless access network. For example, UE 110 and 112 may be connected to and communicate via the same access network node 120. The UEs may communicate with one another via both the access networks and the core network. For example, UE 110 may be connected to the access network node 120 whereas UE 111 may be connected to the access network node 121, and as such, the UE 110 and UE 111 may communicate to one another via the access network nodes 120 and 121, and the core network 130. The UEs may further communicate with the service applications 140 and the data networks 150 via the core network 130. Further, the UEs may communicate to one another directly via side link communications, as shown by 113.

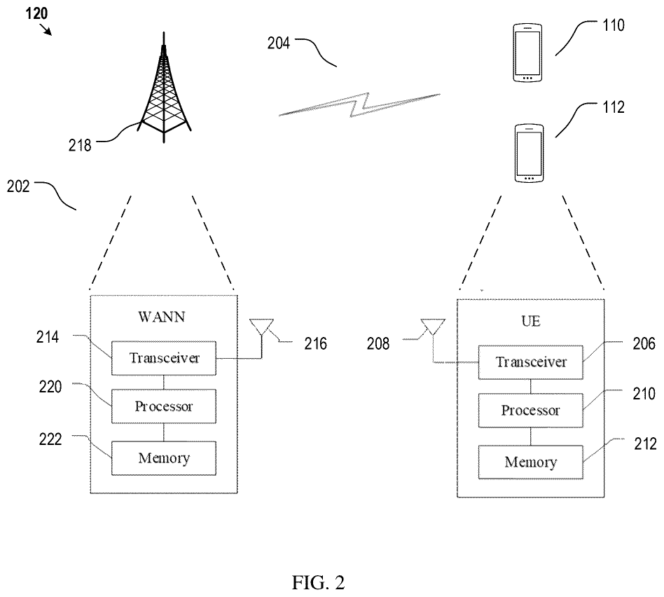

FIG. 2 further shows an example system diagram of the wireless access network 120 including a WANN 202 serving UEs 110 and 112 via the over-the-air interface 204. The wireless transmission resources for the over-the-air interface 204 include a combination of frequency, time, and/or spatial resource. Each of the UEs 110 and 112 may be a mobile or fixed terminal device installed with mobile access units such as SIM/USIM modules for accessing the wireless communication network 100. The UEs 110 and 112 may each be implemented as a terminal device including but not limited to a mobile phone, a smartphone, a tablet, a laptop computer, a vehicle on-board communication equipment, a roadside communication equipment, a sensor device, a smart appliance (such as a television, a refrigerator, and an oven), or other devices that are capable of communicating wirelessly over a network. As shown in FIG. 2, each of the UEs such as UE 112 may include transceiver circuitry 206 coupled to one or more antennas 208 to effectuate wireless communication with the WANN 120 or with another UE such as UE 110. The transceiver circuitry 206 may also be coupled to a processor 210, which may also be coupled to a memory 212 or other storage devices. The memory 212 may be transitory or non-transitory and may store therein computer instructions or code which, when read and executed by the processor 210, cause the processor 210 to implement various ones of the methods described herein.

Similarly, the WANN 120 may include a wireless base station or other wireless network access point capable of communicating wirelessly via the over-the-air interface 204 with one or more UEs and communicating with the core network 130. For example, the WANN 120 may be implemented, without being limited, in the form of a 2G base station, a 3G nodeB, an LTE eNB, a 4G LTE base station, a 5G NR base station of a 5G gNB, a 5G central-unit base station, or a 5G distributed-unit base station. Each type of these WANNs may be configured to perform a corresponding set of wireless network functions. The WANN 202 may include transceiver circuitry 214 coupled to one or more antennas 216, which may include an antenna tower 218 in various forms, to effectuate wireless communications with the UEs 110 and 112. The transceiver circuitry 214 may be coupled to one or more processors 220, which may further be coupled to a memory 222 or other storage devices. The memory 222 may be transitory or non-transitory and may store therein instructions or code that, when read and executed by the one or more processors 220, cause the one or more processors 220 to implement various functions of the WANN 120 described herein.

Data packets in a wireless access network such as the example described in FIG. 2 may be transmitted as protocol data units (PDUs). The data included therein may be packaged as PDUs at various network layers wrapped with nested and/or hierarchical protocol headers. The PDUs may be communicated between a transmitting device or transmitting end (these two terms are used interchangeably) and a receiving device or receiving end (these two terms are also used interchangeably) once a connection (e.g., a radio link control (RRC) connection) is established between the transmitting and receiving ends. Any of the transmitting device or receiving device may be either a wireless terminal device such as device 110 and 120 of FIG. 2 or a wireless access network node such as node 202 of FIG. 2. Each device may both be a transmitting device and receiving device for bi-directional communications.

The core network 130 of FIG. 1 may include various network nodes geographically distributed and interconnected to provide network coverage of a service region of the carrier network 102. These network nodes may be implemented as dedicated hardware network nodes. Alternatively, these network nodes may be virtualized and implemented as virtual machines or as software entities. These network nodes may each be configured with one or more types of network functions which collectively provide the provisioning and routing functionalities of the core network 130.

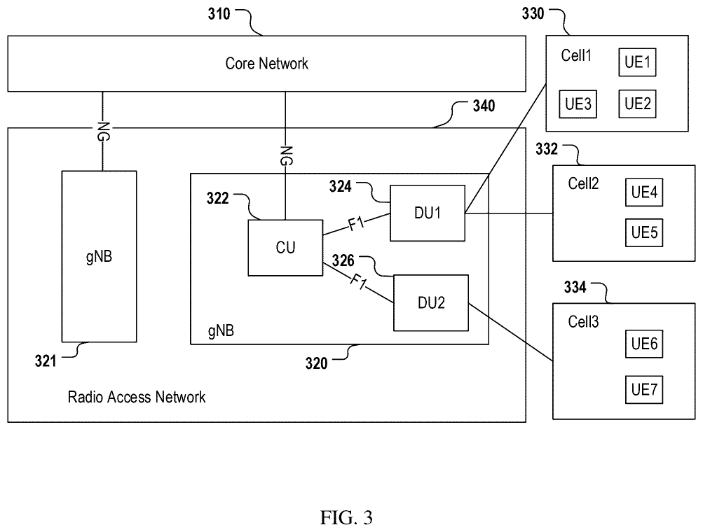

Returning to wireless radio access network (RAN), FIG. 3 illustrates an example RAN 340 in communication with a core network 310 and wireless terminals UE1 to UE7. The RAN 340 may include one or more various types of wireless base station or WANNs 320 and 321 which may include but are not limited to gNB, eNodeB, NodeB, or other type of base stations. The RAN 340 may be backhauled to the core network 310. The WANNs 320, for example, may further include multiple separate access network nodes in the form of a Central Unit (CU) 322 and one or more Distributed Unit (DU) 324 and 326. The CU 322 is connected with DU1 324 and DU2 326 via various interfaces, for example, an Fl interface. The FI interface, for example, may further include an F1-C interface and an F1-U interface, which may be used to carry control plane information and user plane data, respectively. In some embodiments, the CU may be a gNB Central Unit (gNB-CU), and the DU may be a gNB Distributed Unit (gNB-DU). While the various implementations described below are provided in the context of a 5G cellular wireless network, the underlying principles described herein are applicable to other types of radio access networks including but not limited to other generations of cellular network, as well as Wi-Fi, Bluetooth, ZigBee, and WiMax networks.

The UEs may be connected to the network via the WANNs 320 over an air interface. The UEs may be served by at least one cell. Each cell is associated with a coverage area. These cells may be alternatively referred to as serving cells. The coverage areas between cells may partially overlap. Each UE may be actively communicating with at least one cell while may be potentially connected or connectable to more than one cell. In the example of FIG. 1, UE1, UE2, and UE3 may be served by cell1 330 of the DU1, whereas UE4 and UE5 may be served by cell2 332 of the DU1, and UE6 and UE7 may be served by cell3 associated with DU2. In some implementations, a UE may be served simultaneously by two or more cells. Each of the UE may be mobile and the signal strength and quality from the various cells at the UE may depend on the UE location and mobility.

In some example implementations, the cells shown in FIG. 3 may be alternatively referred to as serving cells. The serving cells may be grouped into serving cell groups (CGs). A serving cell group may be either a Master CG (MCG) or Secondary CG (SCG). Within each type of cell groups, there may be one primary cell and one or more secondary cells. A primary cell in a MSG, for example, may be referred to as a PCell, whereas a primary cell in a SCG may be referred to as PScell. Secondary cells in either an MCG or an SCG may be all referred to as SCell. The primary cells including PCell and PScell may be collectively referred to as spCell (special Cell). All these cells may be referred to as serving cells or cells. The term “cell” and “serving cell” may be used interchangeably in a general manner unless specifically differentiated. The term “serving cell” may refer to a cell that is serving, will serve, or may serve the UE. In other words, a “serving cell” may not be currently serving the UE. While the various embodiment described below may at times be referred to one of the types of serving cells above, the underlying principles apply to all types of serving cells in both types of serving cell groups.

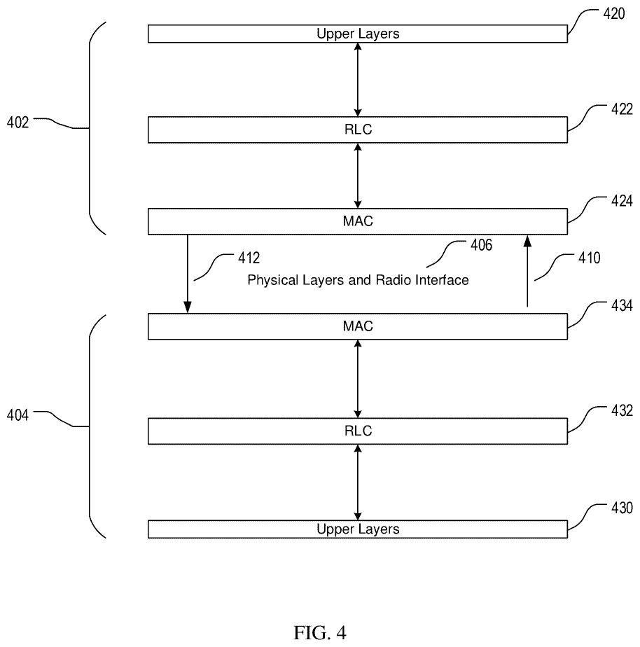

FIG. 4 further illustrates a simplified view of the various network layers involved in transmitting user-plane PDUs from a transmitting device 402 to a receiving device 404 in the example wireless access network of FIGS. 1-3. FIG. 4 is not intended to be inclusive of all essential device components or network layers for handling the transmission of the PDUs. FIG. 4 illustrates that the data packaged by upper network layers 420 at the transmitting device 402 may be transmitted to corresponding upper layer 430 (such as radio resource control or RRC layer) at the receiving device 304 via Packet Data Convergence Protocol layer (PDCP layer, not shown in FIG. 4) and radio link control (RLC) layer 422 and of the transmitting device, the physical (PHY) layers of the transmitting and receiving devices and the radio interface, as shown as 406, and the media access control (MAC) layer 434 and RLC layer 432 of the receiving device. Various network entities in each of these layers may be configured to handle the transmission and retransmission of the PDUs.

In FIG. 4, the upper layers 420 may be referred as layer-3 or L3, whereas the intermediate layers such as the RLC layer and/or the MAC layer and/or the PDCP layer (not shown in FIG. 4) may be collectively referred to as layer-2, or L2, and the term layer-1 is used to refer to layers such as the physical layer and the radio interface-associated layers. In some instances, the term “low layer” may be used to refer to a collection of L1 and L2, whereas the term “high layer” may be used to refer to layer-3. In some situations, the term “lower layer” may be used to refer to a layer among L1, L2, and L3 that are lower than a current reference layer. Control signaling may be initiated and triggered at each of L1 through L3 and within the various network layers therein. These signaling messages may be encapsulated and cascaded into lower layer packages and transmitted via allocated control or data over-the-air radio resources and interfaces. The term “layer” generally includes various corresponding entities thereof. For example, a MAC layer encompasses corresponding MAC entities that may be created. The layer-1, for example, encompasses PHY entities. The layer-2, for another example encompasses MAC layers/entities, RLC layers/entities, service data adaptation protocol (SDAP) layers and/or PDCP layers/entities.

### Time Advance (TA)

For communication in the air interface from each UE to the base station, a timing of an uplink transmission may be controlled according to a Time Advance (TA). The time advance for each UE with respect to a base station helps ensure that uplink transmissions from all UEs are synchronized when received by the base station. The TA for a particular UE in communication with a base station via a serving cell is essentially dependent on a transmission propagation delay which is directly related to a path length from the UE to the base station (for example, the DU above). A UE generally needs to acquire and maintain its TA in relation to a base station to which it communicates in order to effectively control the timing of its uplink signal transmission using any allocated uplink transmission resources.

In a wireless connection based on a random-access procedure, the TA may be initially communicated from the base station to the UE during a random-access process in a Random-Access Response (RAR) after a random-access request by the UE. A time advance may be also communicated to the UE via a MAC Control Element (MAC CE) including a Timing Advance Command (TAC), e.g., for TA updates.

### Time Advance in Multiple Transmit-Receive Point (mTRP) Transmission

Multiple Transmit-Receive Points (mTRP) transmission technology allows wireless access network nodes and a UEs to use different antenna panels and/or RF chains to perform the transmission-reception (RX-TX). In other words, the mTRP technology allow the wireless network and/or a UE to transmit/receive the multiple radio/data streams simultaneously.

For example, a serving cell for a UE may be provided with one or more antenna panels from the network side. Each antenna panel may be configured with multiple beams. A beam may be used as a TRP. As such, mTRP service may be provided by the serving cell to the UE via two or more beams from the same or different antennal panels at the same time. Using mTRP provided by the same serving cell may be referred to as intra-cell mTRP. In some implementations, particularly when the UE is at the cell boundaries and in a region of cell intersections, the serving cell, without handover, may rely on TRP of a neighboring cell to provide mTRP service to the UE. For example, a TRP in the serving cell and another TRP from its neighboring cell may together be used to provide mTRP service to the UE. Such situation may be referred to as inter-cell mTRP. Such neighboring cells, for example, may be managed by the same DU or by DUs managed by the same CU. While it may be allowed to have all TRPs that the serving cell uses for providing the mTRP service to a UE provided from its neighboring, with none from its own cell, such situation may nevertheless be preferably avoided by initiating a handover of the service to one of the neighboring cells.

Each of the TRP may be associated with its own uplink TA depending on the signal path of the corresponding beam from the UE to the TRP. Among all configurable TRPs, a subset, e.g., two or more, of the TRPs may be actively used to provide mTRP service to the UE for uplink transmission at the same time. The UE, for example, may be configured with TA Groups (TAG) to manage uplink TAs. Each TAG may be associated with a TA value to apply for uplink transmission. The UE may be configured to simultaneously manage multiple TAGs identified by TAG IDs in order to maintain multiple TAs. In the single TRP (sTRP) situation, a cell may be associated with one TAG while each TAG may be associated with multiple cells having similar TAs. For the UE to apply a correct TA value for uplink transmission, the UE may obtain a TAG ID from a scheduling message from a serving cell for uplink transmission and use the corresponding TA that is maintained either via initial acquisition or subsequent update from the network.

For the mTRP situation, however, a serving cell may potentially use multiple TRP to serve the UE. The multiple TRPs may be characterized by distinct TAs and thus the TRPs may need to be associated with multiple TAGs. As such, in comparison to sTRP situation, a cell may need to be associated with multiple TAGs in order for the UE to correctly apply the TA when mTRP service is provided.

The further disclosure below describes various example implementations for the serving cell to configure and signal such association to the wireless terminal and for the wireless terminal to obtain initial and updated TAs for these TRPs. Various additional embodiments are further described, providing example procedures for handling uplink Time Alignment Timer (TAT) expiration when multiple TRPs are involved, particularly when TATs for some TRPs have expired whereas TATs for some other TRPs are still available.

### Association of TRPs with TAGs for mTRP

As described above, because each TRP may be associated with its own TA, a serving cell providing multiple TRP to the UE may be associated with multiple TAs that need to be applied by the UE for uplink transmission. These TAs may be sufficiently distinct and thus may not fall into a range that can be represented by a single TAG. In other words, the serving cell may need to be associated with multiple TAGs. Appropriate TAG may need to be identified by the UE in order to transmit to corresponding TRP.

In some example implementations, a serving cell may be configured with two TAGs directly. For example, the two TAGs for a serving cell may be referred to as tag-Id and additonalTag-Id. These two TAG IDs may be configured in the serving cell configuration (e.g., servingCellConfig) directly and be provided through the corresponding configuration message to the UE as its serving cell. Each of these TAG IDs may be associated with or mapped to one TRP of the serving cell and thus mapped to a corresponding TA. The mapping relationship may be made known to the UE by, for example, predefined specification. When scheduling an uplink transmission for the UE, the scheduling message from the serving cell may contain information that allows the UE to determine the the TRP to be used in the uplink transmission, and the UE may then determine the TAG ID mapped to the TRP informed by the serving cell for the uplink transmission, thereby using the correct TA for performing the uplink transmission.

In some further example implementations, the mapping between the TAG IDs configured for the serving sell and the TRPs of the serving cell may be hard specified as a correspondence between TAG IDs to control resource sets (CORESETs) used for scheduling the UE's uplink transmission. For example, the CORESETs may including PDCCH resource sets configured for scheduling the uplink transmission of the UE. The CORESETs may be from multiple pools identified as, for example, CORESETPoolid=0) and CORESETPoolid=1. Each CORESET pool may include a plurality of CORESETs. The correspondence between TAD IDs configured for the serving cell and the CORESET pools may be hard specified. For example, as tag-Id may correspond to CORESETPoolid= (whereas additonalTag-Id may correspond to CORESETPoolid=1, or vice versa. Such implementations would require that the PDCCH resources within each of these CORESET pools may be used to schedule uplink transmission resources used by one corresponding TRP. The TRP associated with a CORESETPoolid is referred to as being represented by the CORESETPoolid.

Thus, in such a manner, uplink transmission scheduled using control resources within CORESETPoolid=0 would be configured to be received by one TRP associated with tag-Id whereas uplink transmission scheduled using control resources within CORESETPoolid=1 would be configured to be received by another TRP associated with additionaltag-Id. The UE, upon receiving a scheduling message (e.g., via a Downlink Control Information (DCI) message), would be able identify the TAG ID (either tag-Id or additionaltag-id) based on the CORESETPoolid to which the control resource of the monitored scheduling message belongs and based on the hard-specified (predefined) relationship between the CORRESETPoolId and the TAG IDs.

In some other example implementations, a serving cell may have a list of the Transmission Configuration Indicator (TCI) states that are used for the UL transmission. Each of these TCI states (rather than the CORESET pools in the example implementations above) may be associated with a TAG. For example, the tag-Id and/or additionalTag-Id is configured in the TCI-State. In such example implementations, the TAG that a TRP belongs to is thus determined by the currently activated/used TCI state for the TRP. A TCI state, in a general sense, may represent a beam or a beam set.

In such example implementations, an association may be configured from TAG to TRP via TCI state. Such association, may be configured dynamically. For example, the relationship between TCI-state and TAG may be dynamically adjusted by a DL Media Access Control (MAC) Control Element (CE). In this example implementations, the DL MAC CE may include at least one of the following information items: 1) serving cell Id: to represent the serving cell the DL MAC CE is applied to; 2) BWP Id: to represent the BWP the DL MAC CE is applied to; 3) TCI state ID: to represent the TCI state Id the DL MAC CE is applied to; 4) tag-Id: to associate the TAG indicated by tag-Id with the indicated TCI state by TCI state ID field.

In some other examples, a serving cell may be configured with a TAG indicated by TAG-Id, and the serving cell may also have a list of the TCI states that are activated or indicated to be used for the UL transmission and each of these TCI states may be associated or configured with a TAG.

As an example for associating the TAG to TRP, the TAG indicated by tag-Id configured in the serving cell configuration (e.g. servingCellConfig) may be fixedly associated with the TRP of the serving cell represented by CORESETPoolId=0.However, the TAG associated with the TRP represented by CORESETPoolId=1 may be determined by the currently activated and/or used TCI state for this TRP. Or vise versa, the TAG indicated by tag-Id configured in the serving cell configuration (e.g. servingCellConfig) may be fixedly associated with the TRP of the serving cell represented by CORESETPoolId=1, whereas the TAG associated with the TRP represented by CORESETPoolId=0 may be determined by the currently activated and/or used TCI state for this TRP.

### TAG/TA management

In the sTRP situation, each cell is associated with one TAG. In mTRP, a cell may be associated with multiple TAGs. The TAGs list may be configured using the following example implementations.

In some example implementations, TAGs for different TRPs of one serving cell may be from a common pool (e.g., tag-ToAddModList). For example, for the TAGs to which the SpCell belongs, the TAG-Id associated with the TRP indicated by CORESETPoolIndex=0 in SpCell may be 0, or the TAG-Id associated with the TRP indicated by CORESETPoolIndex=1 in SpCell may be 0. For another example, the tag-Id configured in the serving cell (e.g., servingCellConfig) is equal to 0.

In some other example implementations, TAG for different TRPs may be from two separate pools (e.g., tag-ToAddModList, additionalTag-ToaAddModList). For example, the TAG configured in the tag-ToAddModlist may be applied to the TRP associated with the TRP indicated by CORESETPoolId=0 in each serving cell, whereas the TAG configured in the additionalTag-ToAddModList (additionTAG-Id) may be applied to the TRP associated with CORESETPoolId=1 in each serving cell, and vice versa.

In such other example implementations, for the TAGs to which the SpCell belong, the TAG Id associated with the TRP indicated by CORESETPoolId=0 may be 0, whereas the additionalTAG Id associated with the TRP indicated by CORESETPoolId=1 may be 0, vice versa.

For DL MAC CE based TA acquisition, in one implementation, to reuse the existing DL TA command MAC CE for indicating the TA of a TAG, if a Time Advance Command (TAC) in the MAC CE is received, the Timing Advance Command may be applied for the TAG associated with the TRP by which the TAC is received.

In some implementation, a new additional TAC in MAC CE may be introduced. The payload of the new additional TAC MAC CE may be the same as the legacy TAC MAC CE with a different Logic Channel ID (LCID).

### Time Alignment Timer (TAT) Expiration Handling for mTRP

In order to maintain synchronization for reception of the uplink transmissions from the UEs at the base station, a Time Alignment Timer (TAT) may be maintained by a UE for each TAG. Such TAT value may be configured and signaled from the base station in various manners. The configured TAT value for a TAG may be used to indicate how long the previously given TA value associated with the TAG is considered as valid. An expiration of the TAT may indicate that the TA is not valid anymore and should be updated before being used for controlling the timing of a corresponding uplink transmission. The TAT can be started or restarted in various situations. For example, the TAT may be started or restart at the UE when the UE receives a Timing Advance Command (TAC) with updated TA for the TAG. A TAC, for example, may be carried in a MAC Random Access Response (RAR) or in a MAC CE.

In an sTRP situation, a serving cell is only associated with one TAG and thus one TAT. When the TAT associated with the serving cell expires, it indicates that the TA associated with the corresponding TAG is no longer valid and no uplink should be transmitted using such expired TA to control its transmission timing. Correspondingly, the UE would then preform a set of flushing, notification, clearing, and other procedures upon a TAT expiration to prevent inadvertent uplink transmission using a wrong TA.

In an mTRP situation, however, a serving cell may be associated with multiple TAGs and each of these TAGS may be managed according to a TAT. As such, multiple TATs may be started, restarted, and may expire at the UE with respect to a serving cell. TATs associated with the serving cell may not expire at the same time. One TAT may expire earlier than another TAT associated with the serving cell. In the situation that some of the TATs associated with the serving cell have expired whereas some other TATs associated with the serving cell have not expired (meaning that those corresponding TAs are still available), the serving cell can still receive uplink transmission using the TRPs corresponding to the unexpired TAs. The various procedures that the UE may perform as following expiration of some TATs may thus be different from the sTRP situation. Various example implementations are further provided below.

In some example implementations, all the TRPs of the serving cells may be treated on the same footing and as such an expiration of a TAT associated with one TRP of the serving cell at the UE may not be treated difference from the expiration of a TAT associated with another TRP of the serving cell. The expiration procedure at the UE, however, may depend on whether TATs of all TAGs associated with the serving cell have expired or not. For the situation that the serving cell is associated with two TAGs and thus two TATs, the example general steps may include:
STEP 1: UE determines whether a TAT of a TAG for a TRP of a serving cell is expired or not. If yes, go to Step 2. If not, go to end.
STEP 2: UE determines whether the TATs of the TAGs for both TRPs of the serving cell are expired. If yes, go to Step 3. If not, go to Step 6.
STEP 3: UE determines whether the serving cell is SpCell or not. If yes, go to Step 4. If not, go to Step 5.
STEP 4: UE performs the following operation: flush all HARQ buffers for all serving cells;
   notify RRC entity to release PUCCH for all serving cells, if configured;
   notify the RRC entity to release Sounding Reference Signal (SRS) for all serving cells, if configured;
   clear any configured downlink assignments and configured uplink grants;
   clear any PUSCH resource for semi-persistent Channel State Information (CSI) reporting;
   consider all running TATs in the MAC entity as expired;
   maintain current TA values (referred to NTA, such that future updates can be made in differential) of all TAGS.
STEP 5: UE performs the following operation:
   flush all HARQ buffers for the serving cell;
   notify the RRC entity to release PUCCH for the serving cell, if configured;
   notify the RRC entity to release SRS for the serving cell, if configured;
   clear any configured downlink assignments and configured uplink grants for the serving cell;
   clear any PUSCH resource for semi-persistent CSI reporting for the serving cell;
   maintain TA values (referred to NTA, such that future updates can be made in differential) of both TAGs.
STEP 6: UE performs the operation according to an example partial expiration procedure as described below, then go to end.

In the example partial expiration procedure, and in the case of two TAGs being associated with and present for the serving cell, it may not be reasonable to flush HARQ buffer, release PUCCH/SRS/of the serving cell, clear CG and/or SPS of the serving cell when the TA of only one of the two TRPs associated with the serving cell is overdue (with expired TAT) and the TA of the other TRP is still available.

As such, for a serving cell, if TATs for both TAGs are expired or TATs for both TRPs are expired, the UE may then consider that the UL transmission for the serving cell as being in a status of out-of-sync, and hence the HARQ buffers shall be flushed, the PUCCH/SRS/shall be released, the CG/SPS shall be cleared, etc. The procedure illustrated above in Step 4 or Step 5 may be performed when TATs for both TAGs are expired or TATs for both TRPs are expired, depending on whether the serving cell is SpCell or not. However, if the TAT of any one TRP is expired and TAT of the other one is still running (e.g., it means that the TA value for such TRP is available), the serving cell is still available for UE to perform the UL transmission with the other TRP, a partial expiration procedure may be performed instead. The partial expiration procedure may be one of the following examples:
The UE may, if the TAT of any one TRP of the serving cell is expired and the TAT of the other TRP is not expired, switch the TCI-state (or beam) of the TRP whose associated TAT is expired to the current TCI-state of the TRP whose associated TAT is not expired automatically (e.g., the mode changed from mTRP (m=2) to STRP). In other words, the UL resources (e.g., the related PUCCH resource (set)/SRS resource (set)/CG/PUSCH Resources for semi-persistent CSI-RS, etc.) associated with the TRP whose associated TAT is expired may be re-associated with the remaining TRP with an unexpired TA;
The UE may, if the TAT of any one TRP of the serving cell is expired and the TAT of the other TRP is not expired, suspend the related UL resources associated with the TRP whose associated TAT is expired. (e.g., the related PUCCH resource (set), SRS resource (set), CG, or SPS, etc.); or
The UE may, if the TAT of any one TRP of the serving cell is expired and the TAT of the other TRP is not expired, release the UL resources associated with the TRP whose associated TAT is expired (e.g., the related PUCCH resource (set), SRS resource (set), CG, or SPS, etc.).

In some other example implementations, the TRPs of the serving cells may be treated differently and as such an expiration of a TAT associated with one TRP of the serving cell at the UE may be treated differently from the expiration of a TAT associated with another TRP of the serving cell. For example, assuming that two TRPs are associated with a serving cell with one of them being treated as a primary TRP and the other one of them being treated as a secondary TRP. For example, a TRP associated with CORESETPoolId=0 may be considered as the primary TRP whereas the other TRP may be considered as the secondary TRP, or vice versa. For another example, for a serving cell, if the TAG that a TRP belongs to is identified by tag-Id present in the serving cell configuration (e.g. servingCellConfig), the TRP is considered as a primary TRP of the serving cell. If the TAG that a TRP belongs to is identified by tag-Id present in the TCI state configuration, the TRP is considered as a secondary TRP of the serving cell. For another example, for a serving cell, if the TAG that a TRP belongs to is identified by tag-Id from a list named tag-ToAddMod1List, the TRP is considered as a primary TRP of the serving cell. If the TAG that a TRP belongs to is identified by additionalTag-Id from a list named additionalTag-ToAddModList, the TRP is considered as a secondary TRP of the serving cell. General expiration procedure may be implemented as the following example steps:
STEP 1. UE determines whether a TAT of a TAG for a TRP is expired or not. If yes, go to Step 2. If not, go to end.
STEP 2: UE determines whether the TRP associated with the expired TAT is a primary TRP (e.g., whether it is associated with the CORESETPoolId=0) or not. If yes, go to Step 3. Otherwise, go to Step 6.
STEP 3: UE determines whether the serving cell the primary TRP belongs to is a SpCell or not. If yes, go to Step 4. Otherwise, go to Step 5.
STEP 4: UE performs the following operation:
   flush all HARQ buffers for all Serving Cells;
   notify RRC to release PUCCH for all Serving Cells, if configured;
   notify RRC to release SRS for all Serving Cells, if configured;
   clear any configured downlink assignments and configured uplink grants;
   clear any PUSCH resource for semi-persistent CSI reporting;
   consider all running TAT as expired;
   maintain TA values (referred to NTA, such that future updates can be made in differential) of all TAGS
STEP 5: UE performs the following operation:
   flush all HARQ buffers for the serving cell;
   notify RRC entity to release PUCCH for the serving cell, if configured;
   notify the RRC entity to release SRS for the serving cell, if configured;
   clear any configured downlink assignments and configured uplink grants for the serving cell;
   clear any PUSCH resource for semi-persistent CSI reporting for the serving cell;
   maintain TA values (referred to NTA, such that future updates can be made in differential) of this TAG.
STEP 6: UE perform the operation according to the implementations as described below, then go to end.

Thus, in the example steps above, for a serving cell, a TAT of a primary TAG is expired (e.g., the TAG of a TRP associated with CORESETPoolID=0), the UE then consider the TA for the serving cell as expired (e.g. consider the serving cell is in the status of UL out-of-sync), regardless of what the status of the TAT for the secondary TRP (e.g. the TAG of the TRP associated with CORESETPoolId=1, or associated with TCI states) is. In such example implementations, if the TA of the TRP is expired and the TRP is a secondary TRP, the serving cell may still be available for UE to perform the UL transmission with the primary TRP.

An example for the procedure referred to in STEP 6, in which the TA for the primary TRP has not expired, may be the following:
The UE may, if the TAT for a secondary TRP is expired and the TAT of the primary TRP is not expired, switch the TCI-state (or beam) of the secondary TRP to the current TCI-state of the primary TRP automatically. In other words, the UL resources (e.g., the related PUCCH resource (set)/SRS resource (set)/CG/SPS, etc.) allocated to or associated with the secondary TRP may be re-allocated to or re-associated with the primary TRP;
The UE may, if the TAT of a secondary TRP is expired and the TAT of the primary TRP is not expired, suspend the related UL resources associated with the secondary TRP of the serving cell (e.g., the related PUCCH resource (set), SRS resource (set), CG, or SPS, etc.); or.
The UE may, if the TAT of a secondary TRP is expired and the TAT of the primary TRP is not expired, release the UL resources associated with the secondary TRP of the serving cell (e.g. the related PUCCH resource (set), SRS resource (set), CG, or SPS, etc.).

In some other example implementations, the two TAGs of the serving cells may be treated differently and as such an expiration of a TAT of a TAG of the serving cell at the UE may be treated differently from the expiration of a TAT of the other TAG of the serving cell. For example, assuming that two TAGs are configuring within a serving cell with one of them being treated as a primary TAG for the serving cell and the other one of them being treated as a secondary TAG for the serving cell. For example, a TAG indicated by tag-Id present in servingCellConfig may be considered as the primary TAG whereas the tag-Id present in TCI-state configuration may be considered as the secondary TAG, or vice versa. For another example, the primary TAG and the secondary TAG are configurable. For another example, the Primary TAG is the TAG indicated by tag-Id from tag-ToAddModList, and the secondary TAG is the TAG indicated by additonalTag-Id from additionalTag-ToAddModList. General expiration procedure may be implemented as the following example steps:
STEP 1. UE determines whether the TAT of a TAG for a serving cell is expired or not. If yes, go to Step 2. If not, go to end.
STEP 2: UE determines whether the TAG is a primary TAG for a serving cell. If yes, go to Step 3. Otherwise, go to Step 6.
STEP 3: UE determines whether the serving cell is the SpCell or not. If yes, go to Step 4. Otherwise, go to Step 5.
STEP 4: UE performs the following operation:
   flush all HARQ buffers for all Serving Cells;
   notify RRC to release PUCCH for all Serving Cells, if configured;
   notify RRC to release SRS for all Serving Cells, if configured;
   clear any configured downlink assignments and configured uplink grants;
   clear any PUSCH resource for semi-persistent CSI reporting;
   consider all running TAT as expired;
   maintain TA values (referred to NTA, such that future updates can be made in differential) of all TAGS
STEP 5: UE performs the following operation:
   flush all HARQ buffers for the serving cell;
   notify RRC entity to release PUCCH for the serving cell, if configured;
   notify the RRC entity to release SRS for the serving cell, if configured;
   clear any configured downlink assignments and configured uplink grants for the serving cell;
   clear any PUSCH resource for semi-persistent CSI reporting for the serving cell;
   maintain TA values (referred to NTA, such that future updates can be made in differential) of this TAGs.
STEP 6: UE perform the operation according to the implementations as described below, then go to end.

Thus, in the example steps above, for a serving cell, a TAT of a primary TAG is expired, the UE then consider the TA for the serving cell as overdue (e.g., consider the serving cell being in the status of the UL out-of-sync), regardless of what the status of the TAT for the secondary TAG is. In such example implementations, for a serving cell, if the TAT of a TAG is expired and the TAG is a secondary TAG, the serving cell may still be available for UE to perform the UL transmission with the TRP associated with the primary TAG.

An example for the procedure referred to in STEP 6, in which the TA for the primary TAG of a serving cell has not expired, may be the following:
The UE may, if the TAT for a secondary TAG is determined as expired and the TAT of the primary TAG is available, switch the TCI-state (or beam) of the TRP associated with the secondary TAG to the current used TCI-state of the TRP associated with the primary TAG automatically. In other words, the UL resources (e.g., the related PUCCH resource (set)/SRS resource (set)/CG/SPS, etc.) allocated to/associated with the TRP belonging to the secondary TAG may be switched to the currently used TCI-state of the TRP belonging to the primary TAG;
The UE may, if the TAT of a secondary TAG is expired and the TAT of the primary TAG is not expired, suspend the related UL resources associated with the TRP belonging to the secondary TAG of the serving cell. (e.g., the related PUCCH resource (set), SRS resource (set), CG, or SPS, etc.); or.
The UE may, if the TAT of a secondary TRP is expired and the TA of the primary TRP is available, release the UL resources associated with the failed secondary TRP belonging to the secondary TAG of the serving cell (e.g., the related PUCCH resource (set)/SRS resource (set)/CG/SPS, etc.). RACH Based TA Acquisition for the TRP Specific TA from Inter-cell mTRP

Generally, TA for the TAGs may be acquired from the network via RACH response. A RACH process may be initiated from the UE after RACH configuration is provided by the network. Alternatively, a RACH process may be ordered by the network via, for example, PDCCH order, referred to as PDCCH ordered RACH. TA value for uplink transmission as a result of the RACH process may be provided to the UE as part of the Random-Access Response (RAR).

For intra-cell TA acquisition for multiple TRPs, the UE may request random-access to the serving cell after receiving RACH configuration as normal and obtain TA for one TRP of the serving cell in order to establish uplink/downlink communication with the serving cell. After that, TAs for other TRPs may be obtained in various manners, such as through MAC CE or through SRS.

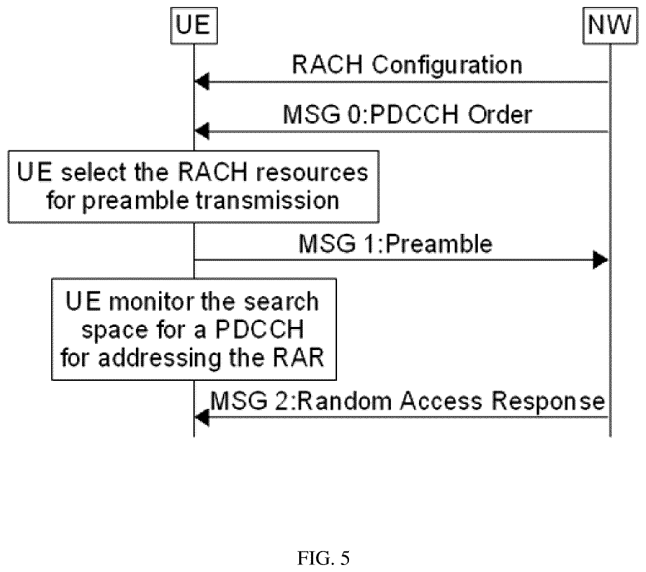

In the inter-cell mTRP situation, one or more TRPs from a neighboring cell other than the serving cell may be involved. In that situation, it may not be desirable for the UE to initiate a normal RACH procedure with the neighboring cell in order to obtain TA specific to those TRPs, which would be akin to a handover procedure. As such, a PDCCH ordered RACH procedure may be implemented for the limited purpose of obtaining the TRP specific TAs. An example TRP specific TA acquisition procedure based on PDCCH ordered RACH process is illustrated in FIG. 5, including the following example steps:
STEP 0: Network (NW) send the RACH Configuration to the UE for the PDCCH ordered RACH for TRP specific TA acquisition.
STEP 1: NW send the PDCCH Order to UE to trigger the RACH for TA acquisition.
STEP 2: UE select RACH resources (RACH occasion) for preamble according to the received PDCCH order in combination with the RACH Configuration.
STEP 3: UE send the indicated preamble on the indicated RACH occasion to NW (via MSG 1, for example).
STEP 4: UE start a random-access response monitoring window, ra-Response Window, and monitor a search space for PDCCH for an RAR reception.
STEP 5: UE receive the RAR from the NW (e.g., via MSG 2) and extract TAC in the RAT for the indicated TAG/TRP.

In further detail, in the Step 0, the RACH configuration for PDCCH ordered RACH may be obtained in the following implementations. The RACH configuration transmission/reception may be performed such that it is differentiated from normal RACH configuration such that the UE would be able to identify RACH resources for TA acquisition without being allocated specific RACH resources. In an example of Step 0, the UE may search for the broadcasted Main Information Block (MIB) of the neighboring cell according to additional PCT index, additionalPCIIndex, and then search for the System Information Block 1 (SIB1) of the neighboring cell according to the received MIB in order to obtain the RACH configuration in the neighboring cell for the PDCCH ordered RACH. In other words, the no specific RACH resources are specified for the UE by the neighboring cell, instead, the UE identify RACH resources for TA acquisition of TRP specific TA in the neighboring cell by monitor broadcast MIB information to identify SIB1 information.

In some other example implementations of Step 0, the RACH configuration for the PDCCH ordered RACH for a serving cell and neighboring cell is explicitly configured in the UL BWP of the serving cell. For example, the RACH configuration may be configured for TRP specific TA acquisition associated with the secondary TRP (e.g., TRP associated with CORESETPoolId=1). For another example, the RACH configuration may be configured for TRP specific TA acquisition associated with the TAG. In yet some other examples, the RACH configuration may be configured for TRP specific TA acquisition associated with the additional PCI index.

In further detail for Step 1 above, corresponding the Specific RACH configuration above, the PDCCH order for the RACH procedure may contain at least one of the following information:
A TRP indication, e.g. CORESETPoolID;
A TAG indication, e.g.: Tag-Id; or
An additional cell indication, e.g.: AdditionalPCIIndex

In further detail for Step 2 above, the following example sub-steps may be applied by the UE:
Sub-step 2-1: To determine whether the RACH is initiated by PDCCH order and the serving cell where RACH is initiated is configured with more than one TAGs. If yes, go to sub-step 2-2. If not, go to sub-step 3.
Sub-step 2-2: To select RACH resources that is associated with the TRP/TAG/AdditionalPCI indicated by PDCCH order or determined by UE according to the PDCCH order.
Sub-step 2-3: To select the RACH resources that is not associated with any TRP/TAG/AdditionalPCI.

Correspondingly the RACH configuration may be designed contain both cell specific RACH configuration, and then a list of RACH configurations in accordance with the above TRP/TAG/AdditionalPCTIndex.

### PDU Set

In some embodiment, multiple PDUs constitute a PDU set. All the PDUs in one PDU set are needed in the receiving side for decoding. If one of the PDUs within the PDU Set exceeds the delay budget or is known to be lost, then all the other PDUs in the PDU Set should be discarded by the transmitting side.

Considering that only PDCP entity (e.g., located in gNB-CU) is aware of which PDUs belong to the same PDU set, and the lower layer (e.g. RLC entity located in gNB-DU) knows which PDU(s) is transmitted unsuccessfully, the lower layers should notify the PDCP entity that the PDU(s) transmitted unsuccessfully once it is detected. If the PDCP entity receives a notification that the first PDU(s) is transmitted unsuccessfully, and the second PDU(s) belonging the same PDU set with the first PDU(s) has been delivered to the Lower layers, the PDCP entity may deliver the information of the second PDU(s) to lower layers so that the lower layers can stop transmitting the second PDU(s).

In summary, the lower layer entity sends the first PDU(s) information that is transmitted unsuccessfully to the upper layer entity; and the upper layer entity sends the second PDU(s) information to the lower layer so that the second PDU(s) is not transmitted anymore (e.g., so that the lower layer stop transmitting the second PDU(s)). Where the first PDU(s) and the second PDU(s) belong to the same PDU set, the lower layer entity is the e RLC entity or gNB-DU, and the upper layer is the e PDCP entity or gNB-CU.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method performed by a wireless terminal in communication with a serving cell, the method comprising:
determining whether a first active Time Alignment Timer (TAT) and a second active TAT have expired, the first active TAT and the second active TAT being associated with a first Time-Advance-Group (TAG) and a second TAG, respectively;
performing a first procedure when determining that the first TAT has expired while the second TAT is still running; and
performing a second procedure when determining that the first TAT and the second TAT have both expired.

2. (canceled)

3. The method of claim 1, wherein the first procedure comprises suspending resources associated with the first TAG.

4. The method of claim 1, wherein the first procedure comprises release resources associated with the first TAG.

5. The method of claim 3, wherein the resources comprise at least one of PUCCH resources and Sounding Reference Signal (SRS) resources.

6. The method of claim 1, wherein the second procedure comprises one or more of:
flushing all Hybrid Automatic Repeat Request (HARQ) buffers for the serving cell;
notifying a Radio Research Control (RRC) entity to release configured PUCCH for the serving cell;
notifying the RRC entity to release configured SRS resources for the serving cell;
clearing configured downlink assignments and uplink grants for the serving cell;
clearing PUSCH resources for semi-persistent Channel-State-Information (CSI) reporting; or
maintaining current time advance values of the first TAG and the second TAG.

7. The method of claim 6, wherein:
the serving cell comprises a special cell (spCell), the special cell being either a primary cell or a primary secondary cell; and
the second procedure further comprises setting all running TATs as expired.

8. (canceled)

9. The method of claim 1, wherein the first TAG and the second TAG correspond to a first activated transmission configuration indicator (TCI) state and a second activated TCI state of the serving cell respectively.

10. The method of claim 1, wherein:
one of the first TAG and the second TAG maps to one of a plurality of Control Resource SET (CORESET) pools configured by the serving cell for the wireless terminal; and
the other of the first TAG and the second TAG correspond to an activated TCI state among a list of TCI states associated with a plurality of TRPs.

11. (canceled)

12. A method performed by a wireless terminal in communication with a serving cell, the method comprising:
determining whether a first time alignment timer (TAT) and a second TAT have expired, the first TAT and the second TAT being associated with a first time advance group (TAG) and a second TAG, respectively;
performing a first procedure when determining that the second TAT has expired while the first TAT is still running; and
performing a second procedure when determining that the first TAT has expired regardless of whether the second TAT has expired.

13. (canceled)

14. The method of claim 12, wherein the first procedure comprises suspending resources associated with the second TAG.

15. The method of claim 12, wherein the first procedure comprises release resources associated with the second TAG.

16. The method of claim 14, wherein the resources comprise at least one of PUCCH resources and Sounding Reference Signal (SRS) resources.

17. The method of claim 12, wherein the second procedure comprises one or more of:
flushing all HARQ buffers for the serving cell;
notifying RRC entity to release configured PUCCH for the serving cell;
notifying the RRC entity to release configured SRS resources for the serving cell;
clearing configured downlink assignments and uplink grants for the serving cell;
clearing PUSCH resources for semi-persistent CSI reporting; or
maintaining current time advance values of the first TAG and the second TAG.

18. The method of claim 17, wherein:
the serving cell comprises a special cell (spCell), the special cell being either a primary cell or a primary secondary cell.

19. (canceled)

20. The method of claim 12, wherein the first TAG and the second TAG correspond to a first activated transmission configuration indicator (TCI) state and a second activated TCI state of the serving cell respectively.

21. The method of claim 12, wherein:
one of the first TAG and the second TAG maps to one of a plurality of CORESET pools configured by the serving cell for the wireless terminal; and
the other of the first TAG and the second TAG correspond to an activated TCI state among a list of TCI states associated with a plurality of TRPs.

22. (canceled)

23. An electronic device, comprising at least one processor and a memory, wherein the at least one processor is configured to read computer code from the memory to cause the electronic device to:
determine whether a first active Time Alignment Timer (TAT) and a second active TAT have expired, the first active TAT and the second active TAT being associated with a first Time-Advance-Group (TAG) and a second TAG, respectively;
perform a first procedure when determining that the first TAT has expired while the second TAT is still running; and
performing a second procedure when determining that the first TAT and the second TAT have both expired.

24. (canceled)

25. The method of claim 1, wherein the first procedure comprises not to flush HARQ buffer, or not to release PUCCH or SRS of the serving cell.

26. The method of claim 1, wherein a list of TCI states that are used for a UL transmission of the wireless terminal is configured in the serving cell, and each of the TCI state is associated with a TAG.

27. The method of claim 1, wherein a random access channel (RACH) configuration for a Physical Downlink Control Channel (PDCCH) ordered RACH is configured in an uplink bandwidth part (UP BWP) of the serving cell, and the RACH configuration is configured for a transmit receive point (TRP) specific TA acquisition associated with an additional physical cell identity (PCI) index.
